(19) United States
(12) Patent Application Publication
(10) Pub. No.: US 2011/0040929 A1
(43) Pub. Date: Feb. 17, 2011

(54) METHOD AND APPARATUS FOR MODIFYING DATA SEQUENCES STORED IN MEMORY DEVICE

(75) Inventors: Yong June KIM, Seoul (KR); Jae Hong KIM, Seoul (KR); Jun Jin KONG, Yongin-si (KR)

Correspondence Address: VOLENTINE & WHITT PLLC, ONE FREEDOM SQUARE, 11951 FREEDOM DRIVE SUITE 1260, RESTON, VA, 20190, US

(73) Assignee: SAMSUNG ELECTRONICS CO., LTD., Suwon-si (KR)

(21) Appl. No.: 12/796,896

(22) Filed: Jun. 9, 2010

(30) Foreign Application Priority Data
Aug. 14, 2009 (KR) 10-2009-0075165

(51) Int. Cl. G06F 12/02; G06F 12/00

(52) U.S. Cl. 711/103; 711/200; 711/E12.001; 711/E12.008

(57) ABSTRACT

A method of modifying data sequences in a memory system comprises receiving program data having a first data sequence, and determining whether the received first data sequence matches one of “m” predefined sequences stored in the memory system. The method further comprises replacing the received first data sequence with a replacement sequence upon determining that the received first data sequence matches one of the “m” predefined sequences, and outputting the replacement sequence from the memory system. The replacement sequence typically comprises pattern bits indicating a pattern of the first data sequence and location bits indicating a start location of the first data sequence.

### CROSS-REFERENCE TO RELATED APPLICATIONS

This application claims priority under 35 U.S.C. §119 to Korean Patent Application No. 10-2009-0075165 filed on Aug. 14, 2009, the disclosure of which is hereby incorporated by reference in its entirety.

### BACKGROUND

Embodiments of the inventive concept relate generally to semiconductor memory devices. More particularly, embodiments of the inventive concept relate to methods and apparatuses for modifying data sequences in memory devices.

Memory devices can be roughly divided into two categories including nonvolatile memory devices and volatile memory devices. Volatile memory devices tend to have faster performance than nonvolatile memory devices, but they lose stored data when disconnected from power. Nonvolatile memory devices, on the other hand, retain stored data even when disconnected from power, such as when a system is shut down or unexpectedly loses power. Accordingly, nonvolatile memory devices are commonly used to provide long term data storage for a variety of different applications.

Examples of nonvolatile memory devices include masked read-only memory (MROM), programmable read-only memory (PROM), erasable programmable read-only memory (EPROM), and electrically erasable programmable read-only memory (EEPROM). Flash EEPROM (hereinafter, “flash memory”) is an increasingly common form of nonvolatile memory due to its relatively high storage capacity, performance, and reliability. Flash memory can currently be found in a wide variety of consumer and industrial devices, such as such as cameras, cell phones, netbooks, portable memory cards, home electronics, network devices, and embedded controllers, to name but a few.

Flash memory is typically programmed in units of several bits at a time, such as one or more pages or words. Each page or word typically corresponds to multiple flash memory cells connected to a common element of the flash memory, such as a common word line. Some flash memory cells can store more than one bit of data. Accordingly, a predetermined group of flash memory cells, such as those connected to a common word line, can be used to store one or more pages or words of data.

Unfortunately, programming certain patterns of data in a flash memory can cause errors in the stored data. For instance, programming patterns of data comprising certain combinations of bits can cause adjacent memory cells to exhibit electrical coupling effects that can lead some bits to be read with erroneous values.

### SUMMARY

The inventive concept provides methods and apparatuses that replace certain data sequences with other data sequences during programming or reading of a memory device. Certain embodiments are capable of improving the performance and reliability of the memory device.

According to one embodiment of the inventive concept, a method of modifying data sequences in a memory system is provided. The method comprises receiving program data from a host, the program data comprising a first data sequence, determining whether the received first data sequence matches one of “m” predefined sequences stored in the memory system, and upon determining that the received first data sequence matches one of the “m” predefined sequences, replacing the received first data sequence with a replacement sequence and outputting the program data with the replacement sequence. The replacement sequence comprises pattern bits indicating a pattern of the first data sequence and location bits indicating a start location of the first data sequence.

In certain embodiments, the first data sequence contains the same number of bits as the replacement sequence. In certain embodiments, the pattern bits have a bit length “b” determined by the value of “m”. In certain embodiments, the bit length “b” is constrained by an inequality log₂ m≦b≦log₂ m+1.

In certain embodiments, the method further comprises receiving read data from a memory device, the read data comprising a second data sequence, determining whether the second data sequence matches the replacement sequence, and replacing the second data sequence with the first data sequence upon determining that the second data sequence matches the replacement sequence.

In certain embodiments, the method further comprises receiving read data comprising a replacement bit indicating whether the read data comprises the replacement sequence, determining a state of the replacement bit, and upon determining that the read data comprises the replacement sequence based on the state of the replacement bit, replacing the replacement sequence with the first data sequence.

In certain embodiments, the method further comprises storing the program data containing the replacement sequence in a memory device.

In certain embodiments, the memory device comprises a multi-level cell flash memory device.

According to another embodiment of the inventive concept, a memory controller comprises a storage unit that stores “m” sequences, and a sequence replacement circuit that receives a first data sequence output from a host, determines whether the first data sequence matches one of the “m” sequences, and upon determining that the first data sequence matches one of the “m” sequences, outputs a replacement sequence to a memory device in place of the first data sequence. The replacement sequence comprises pattern bits indicating a pattern of the first data sequence and location bits indicating a start location of the first data sequence within a larger data sequence.

In certain embodiments, the first data sequence is located in a unit of program data received from the host. In certain embodiments, the sequence replacement circuit receives a second data sequence from the memory device, determines whether the second data sequence matches the replacement sequence, and upon determining that the second data sequence matches the replacement sequence, outputs the first data sequence in place of the second data sequence.

In certain embodiments, the sequence replacement circuit receives read data comprising a replacement bit indicating whether the read data comprises the replacement sequence, determines a state of the replacement bit, and upon determining that the read data comprises the replacement sequence based on the state of the replacement bit, replaces the replacement sequence with the first data sequence.

According to still another embodiment of the inventive concept, a memory system comprises a memory device that stores a replacement sequence, and a controller that replaces a first data sequence with the replacement sequence and stores the replacement sequence in the memory device. The controller comprises a storage unit that stores “m” sequences, and a sequence replacement circuit that receives a first data sequence output from a host, determines whether the first data sequence matches one of the “m” sequences, and upon determining that the first data sequence matches one of the “m” sequences, outputs a replacement sequence to the memory device in place of the first data sequence. The replacement sequence comprises pattern bits indicating a pattern of the first data sequence and location bits indicating a start location of the first data sequence within a larger data sequence.

### BRIEF DESCRIPTION OF THE DRAWINGS

Embodiments of the inventive concept are described below with reference to the accompanying drawings. In the drawings, like reference numbers denote like features.

FIG. 1 is a diagram of a data sequence that may produce errors when stored in adjacent memory cells due to electrical coupling effects between the memory cells.

FIG. 2A is a block diagram of a memory system comprising a sequence replacement unit according to an embodiment of the inventive concept.

FIG. 2B is a block diagram of a memory system comprising a sequence replacement unit according to another embodiment of the inventive concept.

FIG. 3 is a block diagram of the sequence replacement unit illustrated in FIG. 2A or 2B.

FIGS. 4A through 4C are diagrams for explaining sequence replacement operations according to embodiments of the inventive concept.

FIGS. 5A though 5B are diagrams for explaining sequence replacement operations according to another embodiment of the inventive concept.

FIG. 6 is a diagram illustrating a method of performing a sequence replacement operation according to an embodiment of the inventive concept.

FIG. 7 is a flowchart illustrating a method of performing a sequence replacement operation in a memory device according to an embodiment of the inventive concept.

FIG. 8 is a block diagram illustrating an electronic system according to an embodiment of the inventive concept.

### DETAILED DESCRIPTION OF THE EMBODIMENTS

Selected embodiments of the inventive concept are described below with reference to the accompanying drawings. These embodiments are provided as teaching examples and should not be interpreted to limit the scope of the inventive concept.

In the description that follows, numerical terms such as first and second, are used to describe various elements. These elements, however, should not be limited by the numerical terms, which are used merely to distinguish one element from another. For example, a first element could be alternatively termed a second element, and similarly, a second element could be alternatively termed a first element. As used herein, the term “and/or” includes any and all combinations of one or more of the associated listed items.

It will be understood that where an element is referred to as being “connected” or “coupled” to another element, it may be directly connected or coupled to the other element or intervening elements may be present. In contrast, where an element is referred to as being “directly connected” or “directly coupled” to another element, there are no intervening elements present. Other words used to describe the relationship between elements should be interpreted in a similar fashion (e.g., “between” versus “directly between”, “adjacent” versus “directly adjacent”, etc.).

The terminology used herein is for the purpose of describing particular embodiments only and is not intended to be limiting of the described embodiments. As used herein, the singular forms “a”, “an” and “the” are intended to include the plural forms as well, unless the context clearly indicates otherwise. It will be further understood that the terms “comprises”, “comprising,”, “includes” and/or “including”, where used herein, specify the presence of stated features, integers, steps, operations, elements, and/or components, but do not preclude the presence or addition of one or more other features, integers, steps, operations, elements, components, and/or groups thereof.

In certain alternative embodiments, functions or acts of the described embodiments may occur out of the order noted in the figures. For example, two operations shown in succession may in fact be executed substantially concurrently or may sometimes be executed in the reverse order, depending upon the functionality/acts involved.

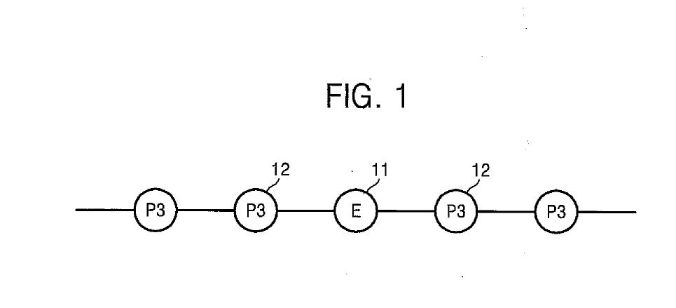

FIG. 1 is a diagram illustrating an example of a program data sequence subject to modification according to an embodiment of the inventive concept.

Referring to FIG. 1, a plurality of flash memory cells 12 having program state “P3” are located adjacent to a flash memory cell 11 having erase state “E”. Due to electrical coupling (e.g., capacitative coupling) between flash memory cells 12 and flash memory cell 11, the threshold voltage of memory cell 11 may be unintentionally elevated, causing flash memory cell 11 to be erroneously read.

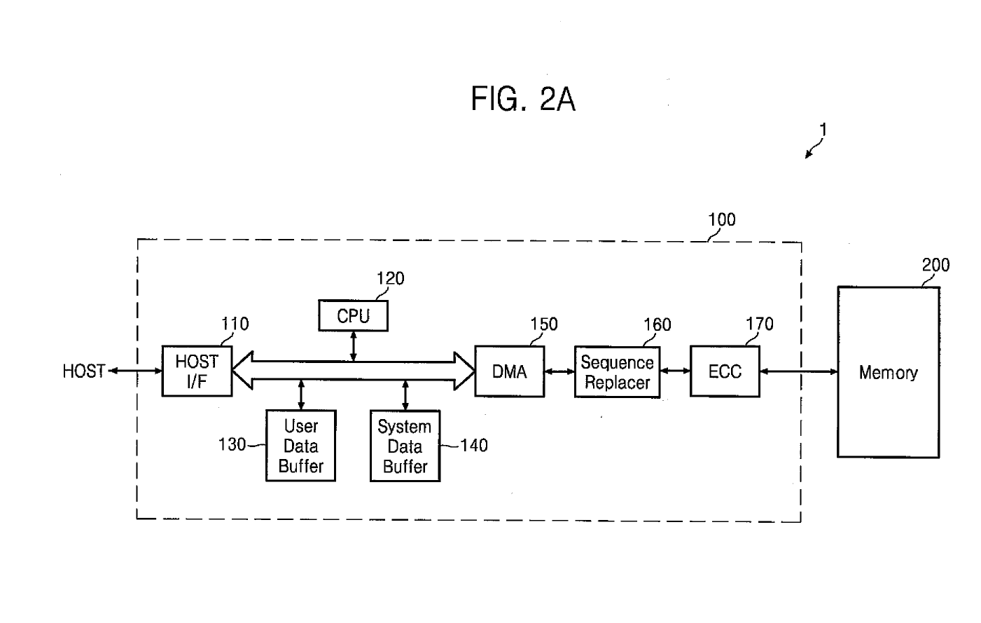

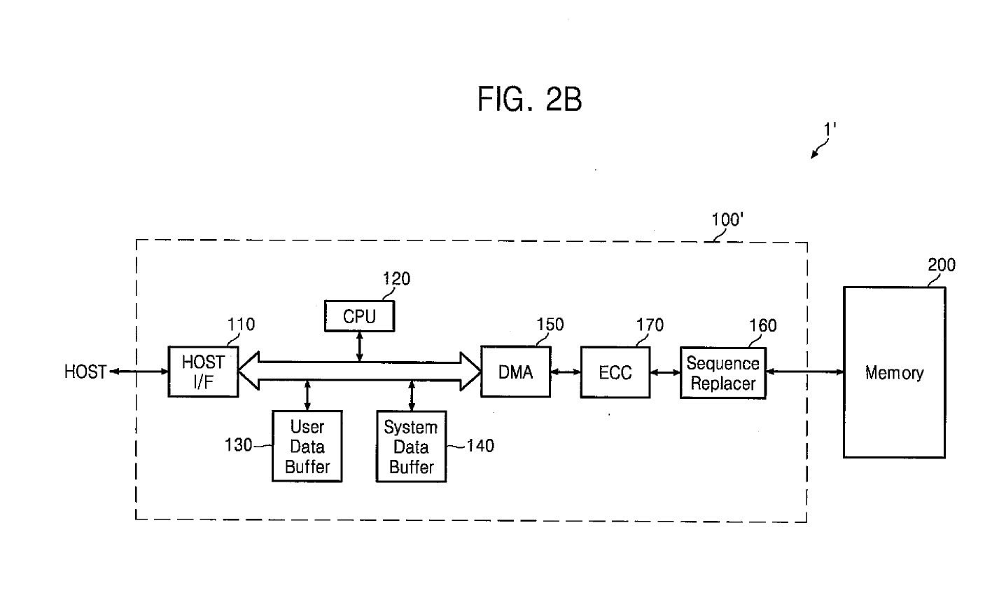

FIG. 2A is a block diagram of a memory system 1 comprising a sequence replacement unit according to an embodiment of the inventive concept. Memory system 1 can be incorporated in any of several different devices or systems, such as a memory card, a smart card, a universal serial bus (USB) memory device, a digital television, a mobile phone, a personal digital assistant (PDA), a personal media player (PMP), or computer, to name but a few.

Referring to FIG. 2A, memory system 1 comprises a controller 100 and a memory device 200. In certain embodiments, memory system 1 further comprises a host.

Controller 100 comprises a host interface 110, a processor such as a CPU 120, a user data buffer 130, a system data buffer 140, a direct memory access (DMA) unit 150, a sequence replacer 160 and an error correction code (ECC) unit 170. These elements are connected to each other by a system bus or a combination of buses and/or other elements, as indicated by arrows in FIG. 2.

Host interface 110 provides an interface for the exchange of commands and data between controller 100 and a host HOST. Host interface 110 typically comprises hardware and/or software for implementing a communication protocol with host HOST.

Memory device 200 comprises a plurality of memory blocks and exchanges data and/or control signals with controller 100 via a plurality of channels connected to the plurality of memory blocks. Memory device 200 typically comprises nonvolatile memory chips, such as NAND flash memory chips and/or NOR flash memory chips.

User data buffer 130 receives and stores program data output from host HOST and read data output from memory device 200. User data buffer 130 receives and stores read data output from memory device 200 while any errors in the read data are detected by ECC unit 170. Where an error is detected in the read data, user data buffer 130 prevents the read data from being transmitted to host HOST under the control of CPU 120. Also under the control of CPU 120, user data buffer 130 corrects errors in the read data based on information of an ECC unit 170 and outputs error-corrected read data to host HOST.

System data buffer 140 receives and stores system data of memory device 200, such as firmware, an operating system, or various forms of code. System data buffer 140 updates and outputs the stored system data to memory device 200 under the control of CPU 120.

Similar to the operation of user data buffer 130, system data buffer 140 receives and stores system data read from memory device 200, and stops any updates of the system data where there is an error in the read system data. System data buffer 140 corrects errors in the read system data based on error information of ECC unit 170 and updates the system data after the correction under the control of CPU 120.

User data buffer 130 and system data buffer 140 typically comprise buffer memories such as single port SRAMs, dual port SRAMs, or multi-port SRAMs. It is not, however, limited to these types of buffer memories.

CPU 120 corrects errors in program data and read data by accessing the program data or read data stored in user data buffer 130 based on error information output from ECC unit 170. To correct errors in the program data or the read data, CPU 120 typically accesses user data buffer 130. Alternatively, memory system 1 may correct errors in program data or read data stored in user data buffer 130 by accessing the data through DMA unit 150.

DMA unit 150 accesses data stored in user data buffer 130 and controls storage of the data in memory device 200. ECC unit 170 corrects errors in the program data received from host HOST and errors in read data received from memory device 200.

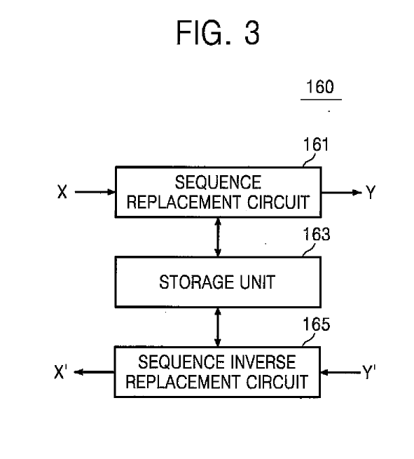

Sequence replacer 160 replaces a predefined data sequence with another sequence based on methods described below with reference to FIGS. 3 through 7. During program operations of memory system 1, sequence replacer 160 replaces certain program data sequences with replacement sequences if at least a part of a unit of program data received from the host is equal to a predefined sequence stored in sequence replacer 160. Moreover, during read operations, sequence replacer 160 replaces replacement sequences with corresponding original sequences.

FIG. 2B illustrates a memory system 1′, which is modified version of memory system 1 illustrated in FIG. 2A. Memory system 1′ is similar to memory system 1, except that in memory system 1′, controller 100 has been replaced with a controller 100′ having sequence replacer 160 and ECC unit 170 in a different arrangement.

In controller 100′, sequence replacer 160 transfers data between memory device 200 and ECC unit 170, and ECC unit 170 transfers data between sequence replacer 160 and DMA unit 150. Otherwise, the functions of sequence replacer 160 and ECC unit 170 are substantially the same in controller 100′ and controller 100. In other words, controller 100′ merely rearranges the order in which error correction is performed by ECC unit 170 and sequence replacement is performed by sequence replacer 160.

FIG. 3 is a block diagram illustrating an embodiment of sequence replacer 60 of FIGS. 2A and 2B. This embodiment will be described in the context of controller 100 of FIG. 2A, and therefore sequence replacer 160 receives program data from DMA unit 150 and receives read data from ECC unit 170.

In a program operation, sequence replacer 160 receives program data X from DMA unit 150 and replaces a data sequence of program data X with another data sequence to produce program data Y. In a read operation, sequence replacer 160 receives read data Y′ from ECC unit 170 and replaces a data sequence in read data Y′ with another data sequence to produce read data X′. In certain embodiments read data X′ corresponds to program data X; both units of data contain the same content. In other words, in certain embodiments, read data X′ is a fully recovered version of program data X.

Referring to FIG. 3, sequence replacer 160 comprises a sequence replacement circuit 161, a storage unit 163, and a sequence inverse replacement circuit 165. Storage unit 163 stores “m” sequences used to perform sequence replacement in circuits 161 and 163.

Sequence replacement circuit 161 receives program data X comprising a first data sequence, and determines whether the first data sequence matches one of the “m” sequences in storage unit 163. Upon determining that the first data sequence matches one of the “m” sequences in storage unit 163, sequence replacement circuit 161 replaces the first data sequence with a second data sequence to produce program data Y. Sequence replacement circuit 161 then outputs program data Y to ECC unit 170.

The second data sequence (also called a “replacement sequence”) comprises pattern bits Ai indicating an index of the first data sequence among the “m” sequences, and location bits Bi indicating a start location of the first data sequence in program data X. The pattern bits Ai, for instance, may comprise an index “i” indicating that the first data sequence matches an “i^{th}” sequence or pattern among the “m” predefined sequences stored in storage unit 163.

Sequence inverse replacement circuit 165 receives read data Y′ output from ECC unit 170 and comprising a second data sequence, determines whether the replacement sequence matches the second data sequence. Upon determining that the replacement sequence matches the second data sequence, sequence inverse replacement circuit 165 outputs read data X′ with the first data sequence instead of the second data sequence to the host.

In some embodiments, read data Y′ comprises a replacement bit indicating whether sequence replacement is required. Where the replacement bit indicates that sequence replacement is required, sequence inverse replacement circuit 165 replaces a second data sequence in read data Y′ with a first sequence to generate read data X′ and outputs data X′ to the host via intervening elements. The replacement bit typically takes values of ‘0’ or ‘1’. A replacement bit with the value ‘0’, for instance, may indicate that the read data Y′ is an original sequence, while a replacement bit with the value ‘1’ may indicate that the read data Y′ contains a replacement sequence.

As indicated above, sequence replacement circuit 161 determines whether incoming program data X contains a sequence matching one of “m” predefined sequences stored in storage unit 163. The incoming program data X, for instance, could contain a sequence ‘000000’ matching one of the “m” predefined sequences. Upon determining that such a match exists, sequence replacement circuit 161 replaces the detected sequence with a replacement sequence.

Since the predefined sequences are stored in storage unit 163, sequence replacement circuit 161 determines whether program data X comprises a sequence to replace by referring to sequences stored in storage unit 163. This can be done, for instance, by storing the “m” sequences in a programmable lookup table (LUT) within storage unit 163.

As illustrated in FIGS. 2A and 2B, sequence replacer 160 can be located in various locations, such as between ECC unit 170 and DMA unit 150, or between ECC unit 170 and memory device 200. In the embodiments of FIGS. 2A and 2B, error correction codes can be generated for program data X or program data Y, i.e., prior or subsequent to sequence replacement.

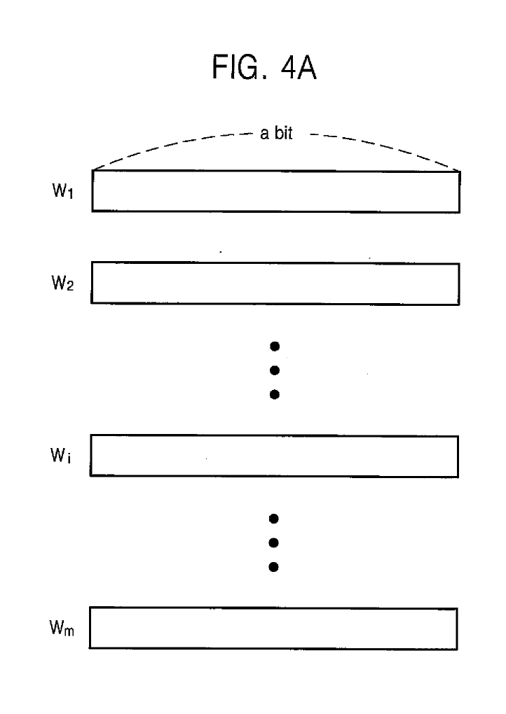

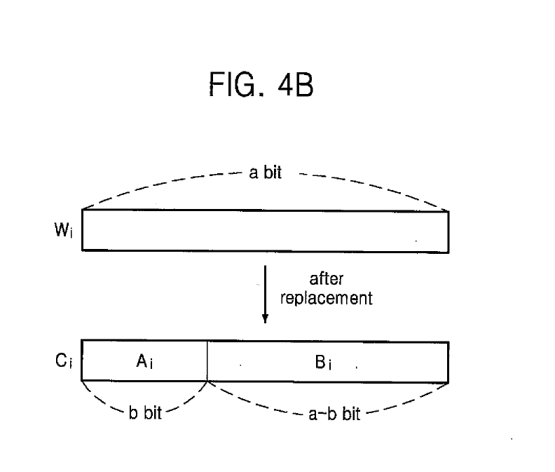

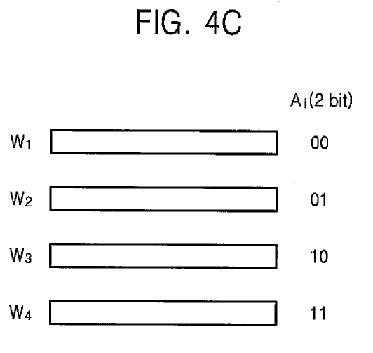

FIGS. 4A to 4C are diagrams illustrating sequence replacement operations according to embodiments of the inventive concept.

FIG. 4A illustrates an example of “m” sequences W1 through Wm stored in storage unit 163 of FIG. 3. In this example, each of the sequences comprises “a” bits. In other words, sequences W1 through Wm are a-bit sequences.

FIG. 4B illustrates the replacement of a sequence Wi in program data X with a replacement sequence Ci by sequence replacer 160. In this example, sequences Wi and Ci have the same bit length. Replacement sequence Ci comprises pattern bits Ai indicating which of the “m” sequences in storage unit 163 matches sequence Wi, and location bits Bi indicating a start location of sequence Wi within program data X.

The bit length “b” of pattern bits Ai can be determined according to the value of “m”. For example, bit length “b” can be determined as a logarithm of “m” as in the following equation 1.

log₂ m≦b<log₂ m+1 (1)

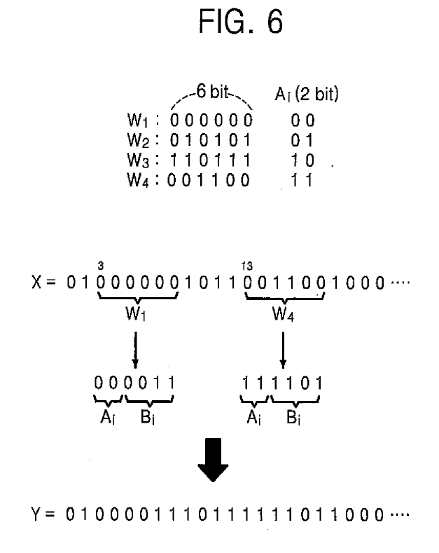

As illustrated in FIG. 4C, where storage unit 163 stores four sequences W1 through W4, the bit length “b” of pattern bits Ai is two. Location bits Bi indicate a start location of sequence Wi within program data X. An example of location bits Bi is explained below with reference to FIG. 6.

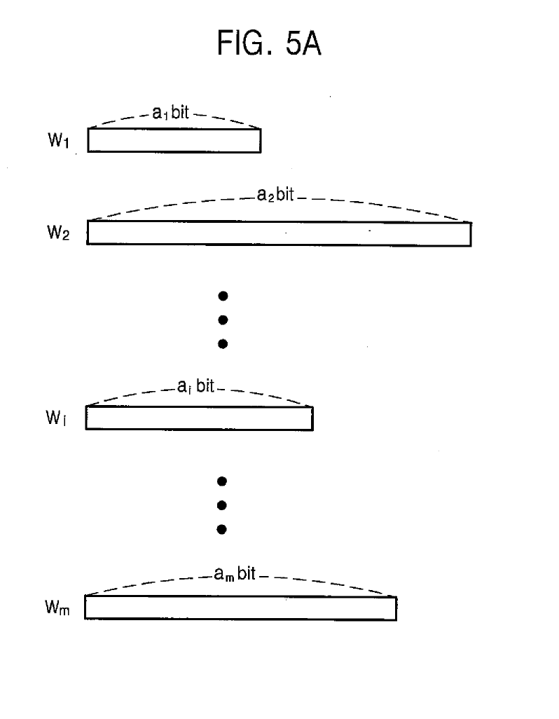

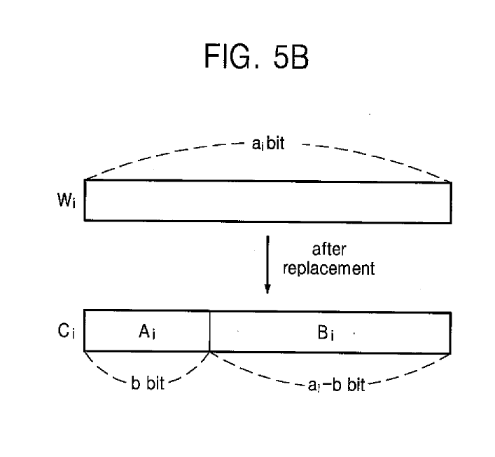

FIGS. 5A and 5B are diagrams for explaining sequence replacement operations according to another embodiment of the inventive concept. In contrast to FIGS. 4A through 4C, which illustrate sequences W1 through Wm with equal bit length “a”, FIGS. 5A and 5B illustrate sequences W1 through Wm with different bit lengths “aᵢ” through “aₘ”.

In the embodiment of FIGS. 5A and 5B, the bit length of pattern bits Ai of sequences W1 through Wm is determined by the value of “m”, similar to FIGS. 4A through 4C. Accordingly, the bit length of pattern bits Ai in replacement sequence Ci of FIGS. 5A and 5B is constant. As illustrated in FIG. 5B, the bit length of location bits Bi of the replacement sequence Ci is (a-b)-bits, where “a” is the bit length of pattern bits Ai.

FIG. 6 is a diagram illustrating a method of performing sequence replacement according to an embodiment of the inventive concept. In this embodiment, four predefined 6-bit sequences W1 through W4 are stored in storage unit 163. Because there are four predetermined sequences, pattern bits Ai are two bits long to distinguish between the four different sequences. In this embodiment, a program data sequence X has 16 possible start locations for the four predetermined sequences, and therefore location bits Bi are four bits long to distinguish between the 16 different possible start locations.

Referring to FIGS. 2 to 6, where sequence W1 (‘00000’), W2 (‘010101’, W3 (‘110111’), or W4 (‘001100’) is included in program data X, sequence replacer 160 replaces each of sequences W1 through W4 with a replacement sequence. The pattern bits of sequence W1 are ‘00’, the pattern bits of sequence W2 are ‘01’, the pattern bits of sequence W3 are ‘10’, and the pattern bits of sequence W4 are ‘11’.

Where program data X is input to sequence replacer 160, sequence replacement circuit 161 compares sequences included in program data X with each of sequences W1 through W4 stored in storage unit 163.

In the example of FIG. 6, a six bit sequence in program data X matches the predefined sequence W1 stored in storage unit 163. Similarly, another six bit sequence in program data X matches the predefined sequence W4 stored in storage unit 163.

The six bit sequence matching sequence W1 is located at a start position “3” in program data X. The pattern bits Ai of this sequence are ‘00’ (to indicate sequence W1) and the location bits Bi of this sequence are ‘0011’ (to indicate start position 3).

The six bit sequence matching sequence W4 is located at a start position “13” in program data X. The pattern bits Ai of this sequence are ‘11’ (to indicate sequence W4) and the location bits Bi of this sequence are ‘1101’ (to indicate start position 13). Replacement sequences are formed by the pattern bits Ai and location bits Bi corresponding to the sequences in program data X that match sequences W1 and W4. The sequences in program data X are replaced with the replacement sequences to produce program data Y to be programmed in memory device 200

As illustrated in FIGS. 4B and 5B, a replacement sequence Ci comprises pattern bits Ai indicating a sequence to be replaced and location bits Bi indicating a start location of the sequence to be replaced. Where the replacement sequence matches one of sequences W1 through W4 stored in storage unit 163, sequence replacer 160 may perform a further replacement on the replacement sequence.

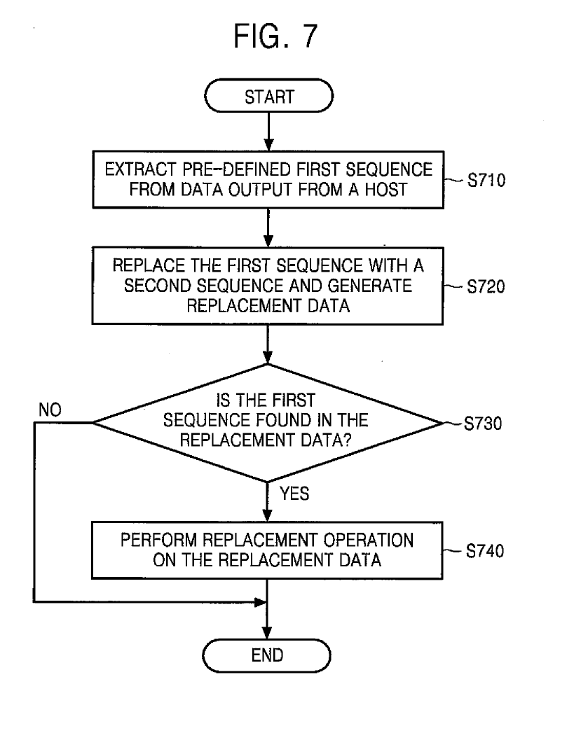

FIG. 7 is a flowchart illustrating a method of replacing program data sequences in a memory device according to an embodiment of the inventive concept. The method of FIG. 7 will be described in the context of memory system 1 illustrated in FIGS. 2A and 3, although the method can be performed by other systems.

Referring to FIGS. 2A, 3, and 7, sequence replacement circuit 161 compares program data X received from a host with “m” predefined data sequences stored in storage unit 163. Upon detecting a match between a first data sequence W1 in program data X, and one of the “m” sequences in storage unit 163, sequence replacement circuit 161 extracts sequence W1 from program data X (S710). Sequence replacement circuit 161 then generates a second data sequence comprising pattern bits Ai indicating a pattern of the first data sequence and location bits Bi indicating a start location of the first data sequence, replaces the first data sequence with the second data sequence, and generates program data Y incorporating the second data sequence (S720).

Sequence replacement circuit 161 then determines whether the predefined first data sequence exists in the program data Y (S730). Where the first data sequence exists in program data Y (S730=Yes), sequence replacement circuit 161 performs a replacement operation on program data Y (S740). Otherwise (S730=No), the method terminates.

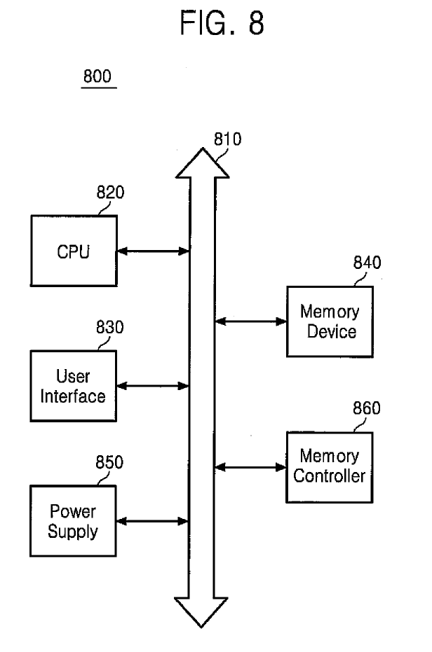

FIG. 8 illustrates an example of an electronic system incorporating a memory device according to an embodiment of the inventive concept. The example system of FIG. 8 can be used to implement various sequence replacement techniques such as those described above.

Referring to FIG. 8, system 800 comprises a CPU 820, a user interface 830, a power supply 850, a memory device 840, and a memory controller 860, connected to each other by a bus and/or network architecture 810. In this example, memory device 840 can be implemented to perform the functions of memory device 200 described above, and memory controller 860 can be implemented to perform the functions of controller 100 or 100′ described above. The operation of these elements can be controlled by CPU 820.

System 800 can take any of several different forms, such as a personal computer, workstation, networking device, gaming-console, handheld device, or embedded system, to name but a few. Additionally, system 800 and its components may be distributed or divided into many sub-components, such as multiple CPU cores, distributed memories, a distributed bus or network architecture, remote user interfaces, and so on.

System 800 may be implemented as a portable or non-portable device. Accordingly, power supply 850 may comprise a portable source of power, such as a battery, or a stationary source of power, such as an alternating current (AC) outlet. Moreover, power supply 850 may comprise more than one source of power for powering different elements of system 800.

Memory device 840 typically comprises one or more nonvolatile memories, such as flash memories. In some embodiments, these memories comprise multi-level cell (MLC) flash memories. Moreover, memory device 840 may comprise more than one memory chip, which may include multiple types and sizes of memories, as well as memories using different protocols. For instance, memory device 840 may comprise a volatile memory such as a DRAM in combination with a nonvolatile memory.

Memory device 840 and any constituent chips may be organized in any of several different architectures. For instance, memory device 840 may be organized in any number of chips, banks, memory blocks, sectors, and so on. Such elements may be arranged in hierarchies (e.g., L2, L3 caches, etc.), in parallel, or in a combination of hierarchical, parallel, or other configuration.

Memory device 840 may be packaged or integrated with other devices to form any of several different products or components. For instance, memory device 840 may be packaged in a memory card or other standalone memory product, or it may form part of a system-on-a-chip having numerous additional elements.

As indicated by the foregoing, various methods and apparatuses for replacing sequences in program data or read data can improve reliability of a memory device by preventing certain patterns of data from being stored together. The foregoing is illustrative of embodiments and is not to be construed as limiting thereof. Although a few embodiments have been described, those skilled in the art will readily appreciate that many modifications are possible in the embodiments without materially departing from the novel teachings and advantages of the inventive concept. Accordingly, all such modifications are intended to be included within the scope of the inventive concept as defined in the claims. Therefore, it is to be understood that the foregoing is illustrative of various embodiments and is not to be construed as limited to the specific embodiments disclosed, and that modifications to the disclosed embodiments, as well as other embodiments, are intended to be included within the scope of the appended claims.

What is claimed is:

1. A method of modifying data sequences in a memory system, comprising:
receiving program data from a host, the program data comprising a first data sequence;
determining whether the received first data sequence matches one of “m” predefined sequences stored in the memory system; and
upon determining that the received first data sequence matches one of the “m” predefined sequences, replacing the received first data sequence with a replacement sequence and outputting the program data with the replacement sequence,
wherein the replacement sequence comprises pattern bits indicating a pattern of the first data sequence and location bits indicating a start location of the first data sequence.

2. The method of claim 1, wherein the first data sequence contains the same number of bits as the replacement sequence.

3. The method of claim 1, wherein the pattern bits have a bit length “b” determined by the value of “m”.

4. The method of claim 3, wherein the bit length “b” is constrained by an inequality log₂ m≦b≦log₂ m+1.

5. The method of claim 1, further comprising:
receiving read data from a memory device, the read data comprising a second data sequence; and
determining whether the second data sequence matches the replacement sequence; and
replacing the second data sequence with the first data sequence upon determining that the second data sequence matches the replacement sequence.

6. The method of claim 1, further comprising:
receiving read data comprising a replacement bit indicating whether the read data comprises the replacement sequence;
determining a state of the replacement bit; and
upon determining that the read data comprises the replacement sequence based on the state of the replacement bit, replacing the replacement sequence with the first data sequence.

7. The method of claim 1, further comprising:
storing the program data containing the replacement sequence in a memory device.

8. The method of claim 7, wherein the memory device comprises a multi-level cell flash memory device.

9. A memory controller, comprising:
a storage unit that stores “m” sequences; and
a sequence replacement circuit that receives a first data sequence output from a host, determines whether the first data sequence matches one of the “m” sequences, and upon determining that the first data sequence matches one of the “m” sequences, outputs a replacement sequence to a memory device in place of the first data sequence,
wherein the replacement sequence comprises pattern bits indicating a pattern of the first data sequence and location bits indicating a start location of the first data sequence within a larger data sequence.

10. The memory controller of claim 9, wherein the first data sequence is located in a unit of program data received from the host.

11. The memory controller of claim 9, wherein the sequence replacement circuit receives a second data sequence from the memory device, determines whether the second data sequence matches the replacement sequence, and upon determining that the second data sequence matches the replacement sequence, outputs the first data sequence in place of the second data sequence.

12. The memory controller of claim 9, wherein the sequence replacement circuit receives read data comprising a replacement bit indicating whether the read data comprises the replacement sequence, determines a state of the replacement bit, and upon determining that the read data comprises the replacement sequence based on the state of the replacement bit, replaces the replacement sequence with the first data sequence.

13. The memory controller of claim 9, wherein the pattern bits have a bit length “b” determined by the value of “m”.

14. The memory controller of claim 13, wherein the bit length “b” is constrained by an inequality log₂ m≦b≦log₂ m+1.

15. A memory system comprising:
a memory device that stores a replacement sequence; and
a controller that replaces a first data sequence with the replacement sequence and stores the replacement sequence in the memory device,
wherein the controller comprises:
a storage unit that stores “m” sequences; and
a sequence replacement circuit that receives a first data sequence output from a host, determines whether the first data sequence matches one of the “m” sequences, and upon determining that the first data sequence matches one of the “m” sequences, outputs a replacement sequence to the memory device in place of the first data sequence,
wherein the replacement sequence comprises pattern bits indicating a pattern of the first data sequence and location bits indicating a start location of the first data sequence within a larger data sequence.

16. The memory system of claim 15, wherein the sequence replacement circuit receives a second data sequence from the memory device, determines whether the second data sequence matches the replacement sequence, and upon determining that the second data sequence matches the replacement sequence, outputs the first data sequence in place of the second data sequence.

17. The memory system of claim 15, wherein the sequence replacement circuit receives read data comprising a replacement bit indicating whether the read data comprises the replacement sequence, determines a state of the replacement bit, and upon determining that the read data comprises the replacement sequence based on the state of the replacement bit, replaces the replacement sequence with the first data sequence.

18. The memory system of claim 15, wherein the memory system is a memory card.

19. The memory system of claim 15, wherein the memory device comprises a multi-level cell flash memory device.

20. The memory system of claim 15, wherein the pattern bits have a bit length determined by the value of “m”.
